(19) United States
(12) Patent Application Publication
(10) Pub. No.: US 2007/0019072 A1
(43) Pub. Date: Jan. 25, 2007

(54) Apparatus for processing digital images

(75) Inventors: Robert J. Bengtsson, Mukilteo, WA (US); Kwun-Wing W. Cheung, Shoreline, WA (US)

Correspondence Address: LEE & HAYES, PLLC, 421 W. RIVERSIDE AVE., SUITE 500, SPOKANE, WA, 99201, US

(73) Assignee: The Boeing Company

(21) Appl. No.: 10/628,745

(22) Filed: Jul. 28, 2003

(51) Int. Cl. H04N 7/18

(52) U.S. Cl. 348/148

(57) ABSTRACT

A vehicle seat for supporting a passenger of a vehicle. The seat includes a seat frame having a mount for mounting the frame to the vehicle, a support extending from the mount, a seat bottom mounted on the support for supporting the passenger when occupying the seat, and a seat back extending upward from the seat bottom. The seat back has a front surface oriented to face the passenger occupying the seat and a rear surface opposite the front surface. A video monitor is mounted on the seat frame, and a digital processor is operatively connected to the video monitor for processing a digital input for display as an image on the video monitor.

### BACKGROUND OF THE INVENTION

The present invention relates generally to processing digital images, and more specifically to an apparatus for processing digital images onboard an aircraft or other vehicle.

Despite the popularity of air travel, passengers are not provided many entertainment options while flying. Although passive entertainment options are offered by airlines, such as in-flight movies and magazines, passengers are offered few personal entertainment activities requiring active participation by the passenger during flight. As digital technology advances, new opportunities arise for airlines to provide active entertainment features for passengers during flight.

### SUMMARY OF THE INVENTION

In one aspect, the present invention includes a vehicle seat for supporting a passenger of a vehicle. The seat includes a seat frame having a mount for mounting the frame to the vehicle, a support extending from the mount, a seat bottom mounted on the support for supporting the passenger when occupying the seat, and a seat back extending upward from the seat bottom. The seat back has a front surface oriented to face the passenger occupying the seat and a rear surface opposite the front surface. A video monitor is mounted on the seat frame, and a digital processor is operatively connected to the video monitor for processing a digital input for display as an image on the video monitor.

In another aspect, the present invention includes a vehicle for transporting a plurality of passengers. The vehicle includes a body having an interior cabin sized and shaped for holding a plurality of passengers, a power plant mounted on the body for generating power to move the body, and a plurality of seats mounted on the body for supporting at least one passenger of the plurality of passengers. At least a portion of the seats of the plurality of seats comprises a seat frame having a mount for mounting the frame to the vehicle, a support extending from the mount, a seat bottom mounted on the support for supporting the passenger when occupying the seat, and a seat back extending upward from the seat bottom. The seat back has a front surface oriented to face the passenger occupying the seat and a rear surface opposite said front surface. A video monitor is mounted on the seat frame, and a digital processor is operatively connected to the video monitor for processing a digital input for display as an image on the video monitor.

Other features of the present invention will be in part apparent and in part pointed out hereinafter.

### BRIEF DESCRIPTION OF THE DRAWING

FIG. 1 is a perspective of a passenger aircraft partially cut away to illustrate an interior cabin of the aircraft;

FIG. 2 is a side elevation of a seat for supporting a passenger of the aircraft;

FIG. 3 is a schematic of a digital image service system of the present invention;

FIG. 4 is a perspective of a portion of an aircraft seat back having components of the digital image service system mounted thereon;

FIG. 5 is an exemplary digital image processed by the digital image service system; and

FIG. 6 is another exemplary digital image processed by the digital image service system.

Corresponding reference characters indicate corresponding parts throughout the several views of the drawings.

### DETAILED DESCRIPTION OF THE PREFERRED EMBODIMENT

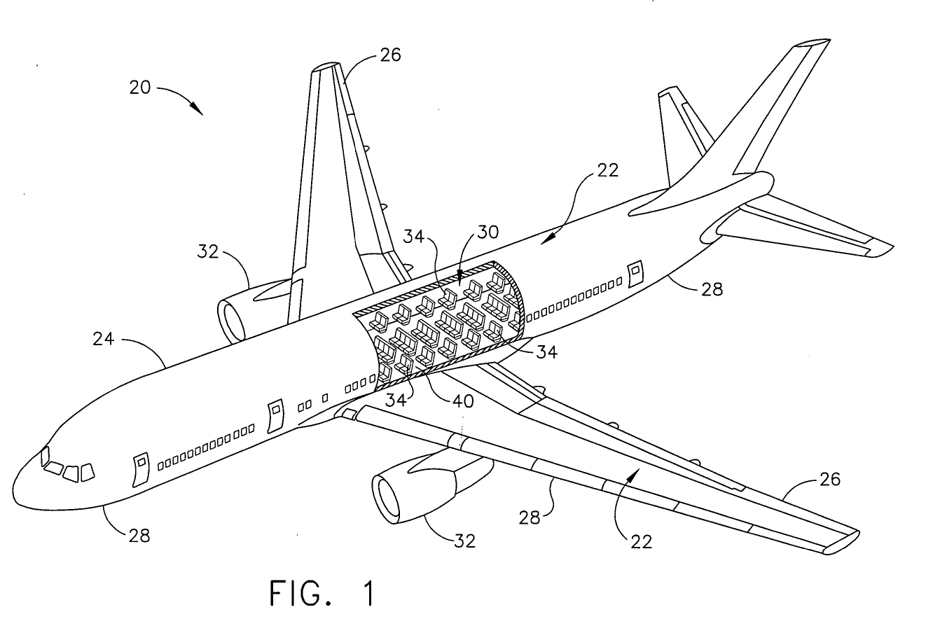

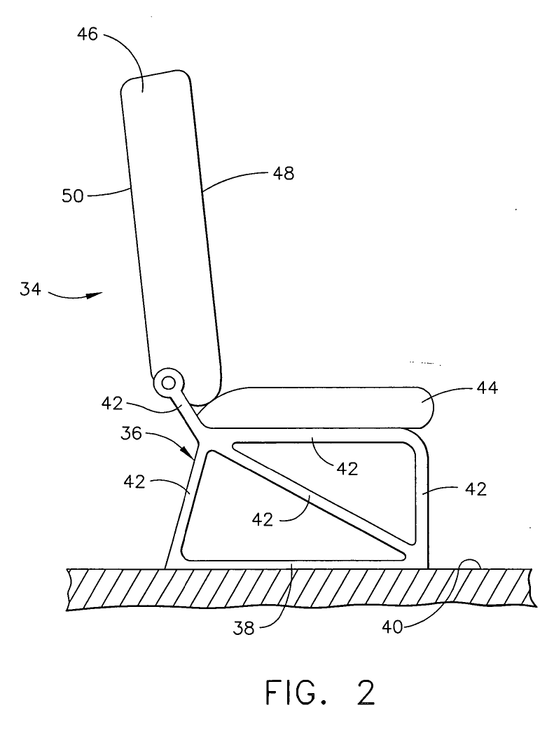

Referring now to the drawings, and more specifically to FIGS. 1 and 2, an aircraft, generally designated by the reference numeral 20, includes an airframe, generally designated by the reference numeral 22, having a fuselage section 24 and a pair of wings 26 extending outward from the fuselage 24. Both the fuselage 24 and the wings 26 are covered in a skin forming an outer surface 28 of the aircraft. The aircraft 20 includes an interior cabin, generally designated by the reference numeral 30, located within the fuselage 24 and sized and shaped to hold a plurality of passengers therein. The aircraft 20 also includes a power plant 32 mounted on the airframe 22 for generating power to move the aircraft. Although the aircraft 20 may include any number of power plants 32 without departing from the scope of the present invention, in the exemplary embodiment the aircraft includes a plurality of power plants 32. Additionally, in the exemplary embodiment, the power plants 32 are gas turbine engines. The aircraft 20 also includes a plurality of seats, generally designated by the reference numeral 34, mounted on the airframe 22 within the interior cabin 30 for supporting passengers occupying the seats 34. Because most of the features of the aircraft 20 are conventional, general features of the aircraft will not be described in further detail.

As illustrated in FIG. 2, each seat 34 includes a seat frame, generally designated by the reference numeral 36, including a mount 38 for mounting the seat frame 36 to a floor 40 of the interior cabin 30 (FIG. 1) in any suitable manner. In one embodiment, the seat frames 36 are mounted to the floor 40 on tracks (not shown) to permit repositioning of seats on the interior cabin floor 40. A plurality of supports 42 extend from the mount 36 and a seat bottom 44 is mounted on the supports 42 for supporting a passenger occupying the seat 34. A seat back 46 extending upward from the seat bottom 44 is mounted on the supports 42 for supporting the back of a passenger occupying the seat 34. The seat back 46 has a front surface 48 orientated to face the passenger occupying the seat 34 and a rear surface 50 opposite the front surface 48. The rear surface 50 of the seat back 46 is orientated to face a passenger occupying another generally identical seat 34 (not shown) mounted on the interior cabin floor 40 generally behind the seat 34 illustrated in FIG. 2.

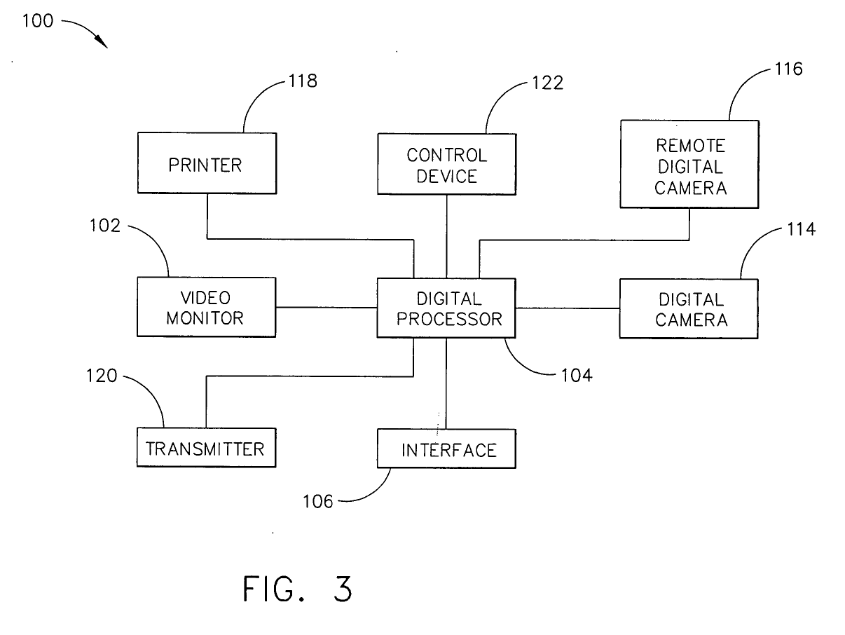

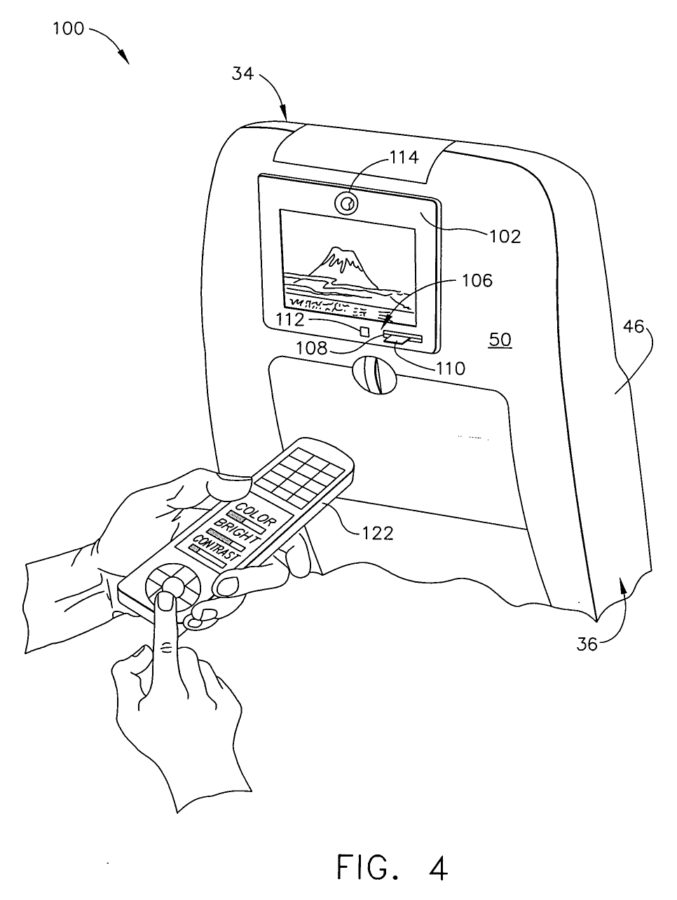

FIG. 3 is a schematic of a digital image service system of the present invention, generally designated by the reference numeral 100, for processing digital images onboard the aircraft 20 (FIG. 1). FIG. 4 is a perspective of a portion of an aircraft seat back 46 having components of the digital image service system 100 mounted thereon. The digital image service system 100 includes a video monitor 102 mounted on the seat frame 36 for displaying digital images. In one embodiment, the video monitor 102 is mounted on the rear surface 50 of the seat back 46 for viewing from behind the seat 34. As illustrated in FIG. 3, the video monitor 102 is operatively connected to a digital processor 104 configured to process digital images, and more specifically to process digital inputs for display as images on the video monitor 102. At least one interface, generally designated by the reference numeral 106, is operatively connected to the digital processor 104 for connecting the digital processor to an external data source (not shown), such as, for example, a digital camera (as will be described below), a personal computer (not shown), a personal digital assistant (not shown), and/or a data storage card. The digital processor 104 receives digital inputs from the external devices for processing and display as images on the video monitor 102. In one embodiment, the interface 106 is a data port selected from a group of data ports consisting of a serial port, a parallel port, a small computer system interface (SCSI) port, a universal serial bus (USB) port, and a card reader. Although the digital processor 104 may have any number and type of interfaces 106 without departing from the scope of the present invention, in the exemplary embodiment illustrated in FIG. 4 the system 100 includes a card reader 108 for receiving digital inputs from a data storage card 110, and a USB port 112 for receiving digital inputs from the external devices.

As further illustrated in FIG. 4, a digital camera 114 is mounted on the seat frame 36 and is operatively connected to the digital processor 104 for providing digital input to the processor 104, and more specifically for providing digital input representative of images recorded by the camera 114. In one embodiment, the digital camera 114 is mounted on the rear surface 50 of the seat back 46 for recording images of objects (e.g., passengers) positioned behind the seat 34. Additionally, the digital processor 104 may be operatively connected to a digital camera 116 (FIG. 3) remote from the seat 34 (e.g., mounted on a cab in bulkhead (not shown)) for receiving digital input representative of images recorded by the remote digital camera 116. In one embodiment, the remote digital camera 116 is mounted to the outer surface 28 (FIG. 1) of the aircraft 20 for recording images of an environment surrounding the aircraft 20 while the aircraft 20 is in-flight or on the ground.

As illustrated in FIG. 3, in one embodiment, the digital processor 104 is operatively connected to a printer 118 located onboard the aircraft 20 for printing images processed by the processor 104. Additionally, in one embodiment a transmitter 120 is operatively connected to the digital processor 104 for sending digital information output by the processor 104 to a location remote from the aircraft 20, such as a printer in an airport terminal (not shown) or over the internet to an email address.

A control device 122 is operatively connected to the digital processor 104 for controlling operation of the digital image service system 100. In the exemplary embodiment, the control device 122 is a remote control device operatively connected to the processor 104 by an electromagnetic signal (e.g., an infrared signal). However, in an alternative embodiment the control device 122 may be mechanically connected to the processor 104 via a cable (not shown) or other suitable means. In one embodiment, the rear surface 50 of the seat back 46 includes a cradle (not shown) for retaining the control device 122 on the seat back 46. The control device 122 is configured to control operation of the digital processor 104, the video monitor 102, the digital camera 114, and the printer 118. In one embodiment, the control device 122 is also configured to control operation of the transmitter 120 and/or the remote digital camera 116. Additionally, in one embodiment the control device 120 is configured to control color, brightness, and contrast of the video monitor 102.

In operation, the digital processor 104 is configured to organize and edit a plurality of digital images selected from the digital inputs received from the external devices. Additionally, in one embodiment the digital processor 104 is configured to generate a digital travel album from the plurality of images, add text to the plurality of images, and generate a digital travel log including text and images selected from the plurality of images. Specifically, a passenger on-board the aircraft 20 can input digital information representing digital images from an external device to the processor 104. Additionally, using the control device 122 the passenger can record digital images of the passenger and other passengers occupying seats 34 adjacent to the passenger using the digital camera 114 mounted on the seat back 46. The digital images recorded by the camera 114 are then input to the processor 104 as digital information representing the images. Additionally, the passenger can input digital images recorded by the remote digital camera 116 to the processor 104. In one embodiment, the passenger can selectively record digital images of the environment surrounding the aircraft 20 using the control device 122 and the remote digital camera 116.

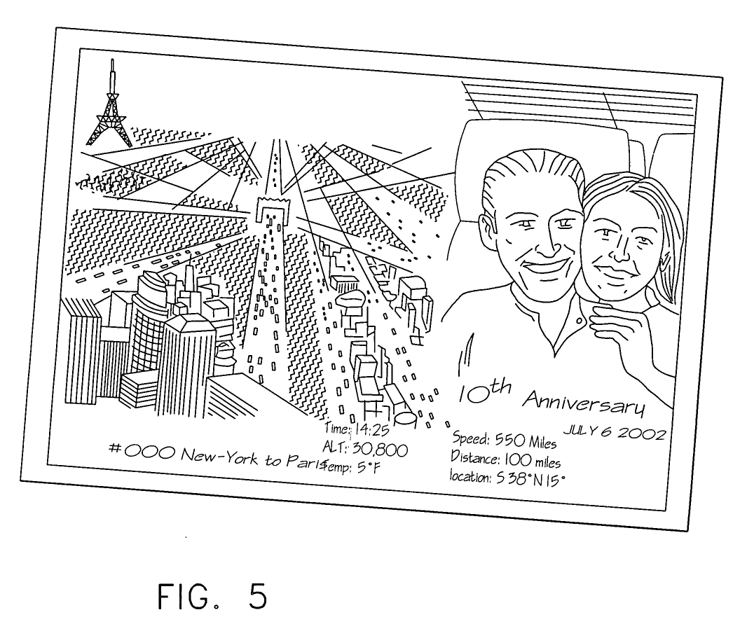

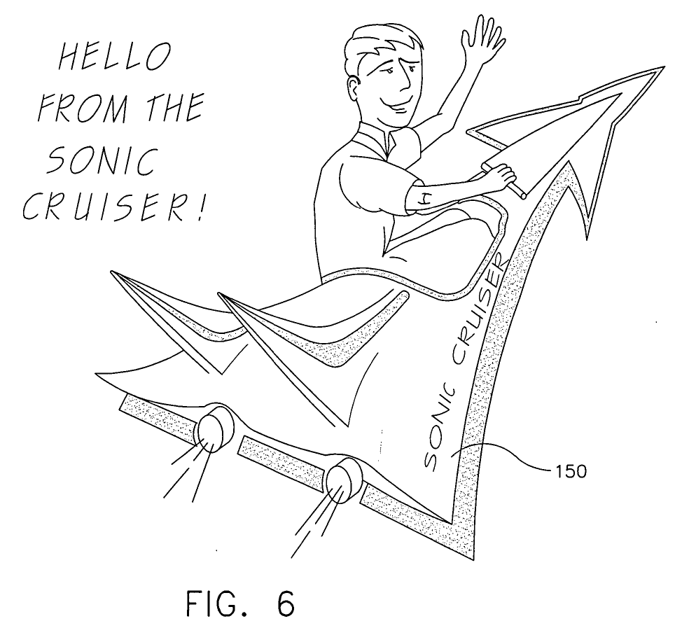

The processor 104 displays the digital images on the video monitor 102 and using the control device 122 the passenger can organize and edit the digital images displayed on the monitor 102. Using the system 100, the passenger can organize the digital images into a digital travel album, add text to each image, and organize a digital travel log. As illustrated in FIG. 5, in one embodiment the passenger can add an airline logo, a date, a position of the aircraft 20, an airspeed of the aircraft 20, and weather conditions surrounding the aircraft 20 to the digital images using the system 100. Additionally, in one embodiment the passenger can merge a plurality of digital images into one digital image using the system 100. For example, as illustrated in FIG. 5 a single digital image processed by the system 100 may include an image recorded by the digital camera 114 and an image recorded by the remote digital camera 116. As illustrated in FIG. 6, in one embodiment the processor 104 stores at least one promotional image 150 therein and is configured to allow a passenger to create a souvenir by merging a digital image of the passenger recorded by the camera 114 with the promotional image 150. In one embodiment, the processor 104 also includes at least one game or amusement activity stored therein to entertain passengers during flight.

Using the interfaces 106, a passenger may download select digital images, a finished digital travel album and/or travel log to an external device, such as a portable computer or a personal digital assistant. In one embodiment, the passenger may print select digital images processed by the system 100 on the printer 118 located onboard the aircraft. Additionally, the passenger may print a finished digital travel album and/or digital travel log on the printer 118. As an added service onboard the aircraft 20, the printed travel album and/or travel log may be bound onboard the aircraft 20 for delivery to the passenger at the end of a flight and/or for mailing to the passenger or to the passenger's family and friends. Furthermore, using the transmitter 120, select digital images, a finished digital travel album, and/or a finished digital travel log may be electronically transmitted to a location remote from the aircraft, such as an airport terminal and/or an electronic address of the passenger or the passenger's friends and family. The passenger can electronically download the transmitted digital images, travel album, and/or travel log to an external device at the airport terminal. Alternatively, the passenger can print the transmitted digital images, travel album, and/or travel log at the airport terminal. As an added service, the printed digital images, travel album, and/or travel log may be bound at the airport terminal, and/or may also be mailed to the passenger or to the passenger's friends and family from the terminal.

Additionally, the digital camera 114 mounted on the seat back 46 may be used for security onboard the aircraft 20. More specifically, a crew onboard the aircraft 20 and/or airline personnel on the ground may use the digital camera 114 to verify the identity and behavior of passengers seated behind the seat 34.

The above-described digital image service system is cost-effective and reliable for processing digital images on-board an aircraft or other vehicle. The system allows passengers to capture the events of a trip or adventure while still traveling thereby creating a record for sharing their adventure and passing time during the trip. More specifically, using the above-described system passengers can organize and edit digital images downloaded from an external device and/or recorded by a digital camera to create select digital images, a digital travel album, and a digital travel log onboard the vehicle. The finished images, album, and log may be printed on-board the vehicle, electronically transmitted to the passenger and the passenger's friends and family during travel, or alternatively mailed to the passenger and the passenger's friends and family when the trip is complete.

Although the invention is herein described and illustrated in association with an aircraft, and more specifically, in association with a seat for an aircraft, it should be understood that the present invention is generally applicable to a seat for any vehicle. Accordingly, practice of the present invention is not limited to aircraft seats, nor is practice of the present invention limited to aircraft generally.

Exemplary embodiments of digital image service systems are described above in detail. The systems are not limited to the specific embodiments described herein, but rather, components of each system may be utilized independently and separately from other components described herein. Each digital image service system component can also be used in combination with other digital image service system components.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A vehicle seat for supporting a passenger of a vehicle, said seat comprising:
a seat frame having a mount for mounting the frame to the vehicle, a support extending from the mount, a seat bottom mounted on the support for supporting the passenger when occupying the seat, and a seat back extending upward from the seat bottom, said seat back having a front surface oriented to face the passenger occupying the seat and a rear surface opposite said front surface;
a video monitor mounted on the seat frame; and
a digital processor operatively connected to the video monitor for processing a digital input for display as an image on the video monitor.

2. A vehicle seat in accordance with claim 1 wherein the video monitor is mounted on the rear surface of the seat back for viewing from behind the vehicle seat.

3. A vehicle seat in accordance with claim 1 wherein the digital processor includes an interface for connecting the processor to an external data source.

4. A vehicle seat in accordance with claim 3 wherein the external data source for which the interface is configured is selected from a group consisting of a digital camera, a personal computer, a personal digital assistant and a data storage card.

5. A vehicle seat in accordance with claim 3 wherein the interface includes a data port selected from a group of data ports consisting of a serial port, a parallel port, a small computer system interface (SCSI) port, and a universal serial bus (USB) port.

6. A vehicle seat in accordance with claim 1 wherein said digital processor is configured to organize and edit a plurality images selected from the digital input.

7. A vehicle seat in accordance with claim 6 wherein said processor is configured to generate a digital travel album from said plurality of images.

8. A vehicle seat in accordance with claim 7 wherein said processor is configured to add text to at least one image of said plurality of images.

9. A vehicle seat in accordance with claim 6 wherein said processor is configured to generate a digital travel log including text and the plurality of images.

10. A vehicle seat in accordance with claim 1 further comprising a digital camera mounted on said seat frame operatively connected to said processor for providing digital input to the processor.

11. A vehicle seat in accordance with claim 10 wherein the digital camera is mounted on the rear surface of the seat back for recording images of behind the vehicle seat.

12. A vehicle seat in accordance with claim 1 further comprising a control device operatively connected to said processor for controlling operation of said processor.

13. A vehicle seat in accordance with claim 12 wherein said control device comprises a remote control device operatively connected to said processor by an electromagnetic signal.

14. A vehicle seat in accordance with claim 1 wherein said processor is operatively connectable to a printer for printing images.

15. A vehicle seat in accordance with claim 1 wherein said processor is operatively connectable to a camera remote from the seat for providing digital input to the processor.

16. A vehicle seat in accordance with claim 15 in combination with the vehicle wherein the camera is mounted on an exterior surface of the vehicle.

17. A vehicle seat in accordance with claim 1 wherein the said processor is operatively connectable to a transmitter for sending information output by the processor to a location remote from the vehicle.

18. A vehicle for transporting a plurality of passengers, said vehicle comprising:
a body having an interior cabin sized and shaped for holding a plurality of passengers;
a power plant mounted on the body for generating power to move body;
a plurality of seats mounted on the body for supporting at least one passenger of said plurality of passengers, at least a portion of said seats of said plurality of seats comprising:
a seat frame having a mount for mounting the frame to the vehicle, a support extending from the mount, a seat bottom mounted on the support for supporting the passenger when occupying the seat, and a seat back extending upward from the seat bottom, said seat back having a front surface oriented to face the passenger occupying the seat and a rear surface opposite said front surface;
a video monitor mounted on the seat frame; and
a digital processor operatively connected to the video monitor for processing a digital input for display as an image on the video monitor.

19. A vehicle in accordance with claim 18 wherein the body comprises an airframe.
